(19) United States
(12) Patent Application Publication
(10) Pub. No.: US 2025/0218038 A1
(43) Pub. Date: Jul. 3, 2025

(54) IMAGE GENERATING SYSTEM HAVING HIGH FACE POSITIONING PRECISION AND METHOD THEREOF

(71) Applicant: SPEED 3D Inc., Taipei City (TW)

(72) Inventors: Li-Chuan Chiu, Taipei City (TW); Jui-Chun Chung, Taipei City (TW); Yi-Ping Cheng, Taipei City (TW); Cheng-Wen Yin, Taipei City (TW)

(73) Assignee: SPEED 3D Inc., Taipei City (TW)

(21) Appl. No.: 18/617,621

(22) Filed: Mar. 26, 2024

(30) Foreign Application Priority Data
Jan. 2, 2024 (TW) 113100253

(51) Int. Cl. G06T 7/73; G06T 7/33; G06T 17/00; G06T 19/20

(52) U.S. Cl. CPC G06T 7/75; G06T 7/344; G06T 17/00; G06T 19/20; G06T 2207/30201; G06T 2219/2004

(57) ABSTRACT

An image generating system having high face positioning precision includes an image converting module and an image generating module. The image converting module analyzes the face of an image via an artificial intelligence model to generate a plurality of feature points, each with a feature point coordinate. The image generating module saves a lookup table and a default grid model having a plurality of grid points. The number of the feature points is equal to that of the grid points. The lookup table records the grid point coordinate of the grid point corresponding to the feature point coordinate of each feature point. The image generating module finds out the feature points matching the grid points, and aligns at least a portion of the grid points with the feature points corresponding thereto so as to combine the default grid model with the face and generate a real-time 3D face model.

### BACKGROUND OF THE INVENTION

### 1. Field of the Invention

The present invention relates to an image generating system, in particular to an image generating system having high face positioning precision. The present invention further relates to the image generating method of the system.

### 2. Description of the Prior Art

Currently available image generation systems usually perform face landmark detection based on two-dimensional coordinate information (such as 106 feature points) to identify faces in images, in order to combine decorative elements (such as hats, beards, glasses, etc.) with the faces in the images. In this way, the combined images can be generated. However, images generated via the above techniques may suffer from fragmentation or distortion. Therefore, the currently available image generation systems still need to be further improved.

### SUMMARY OF THE INVENTION

One embodiment of the present invention provides an image generating system having high face positioning precision, which includes an image converting module and an image generating module. The image converting module analyzes the face of an image via an artificial intelligence model to generate a plurality of feature points. Each of feature points has a feature point coordinate. The image generating module saves a lookup table and a default grid model having a plurality of grid points. The number of the feature points is equal to the number of the grid points. The lookup table records the grid point coordinate of the grid point corresponding to the feature point coordinate of each of the feature points. The image generating module finds out the feature points matching the grid points, and aligns at least a portion of the grid points with the feature points corresponding thereto so as to combine the default grid model with the face and generate a real-time three-dimensional (3D) face model.

In one embodiment, the image generating module aligns at least a portion of the grid points with the feature points corresponding thereto without breaking or distorting the default grid model.

In one embodiment, the image generating module arranges the grid points not matching the feature points according to the shape of the default grid model.

In one embodiment, the image generating module arranges the feature points unable to be identified by the image generating module according to the shape of the default grid model.

In one embodiment, the system further includes an image combining module. The image combining module combines the real-time 3D face model with a decorative image to generate a combined image.

Another embodiment of the present invention provides an image generating method having high face positioning precision, which includes the following steps: analyzing the face of an image via an artificial intelligence model to generate a plurality of feature points, wherein each of feature points has a feature point coordinate; providing a lookup table and a default grid model having a plurality of grid points, wherein the number of the feature points is equal to the number of the grid points, and the lookup table records the grid point coordinate of the grid point corresponding to the feature point coordinate of each of the feature points; finding out the feature points matching the grid points according to the lookup table; and aligning at least a portion of the grid points with the feature points corresponding thereto so as to combine the default grid model with the face and generate a real-time 3D face model.

In one embodiment, the step of aligning at least a portion of the grid points with the feature points corresponding thereto so as to combine the default grid model with the face and generate the real-time 3D face model further includes the following step: aligning at least a portion of these grid points with the feature points corresponding thereto without breaking or distorting the default grid model.

In one embodiment, the method further includes the following step: arranging the grid points not matching the feature points according to the shape of the default grid model.

In one embodiment, the method further includes the following step: arranging the feature points unable to be identified according to the shape of the default grid model.

In one embodiment, the method further includes the following step: combining the real-time 3D face model with a decorative image to generate a combined image.

The image generating system having high face positioning precision and the method thereof in accordance with the embodiments of the present invention may have the following advantages:

(1) In one embodiment of the present invention, the image generating system having high face positioning precision includes an image converting module, an image generating module and an image combining module. The image converting module analyzes the face of an image via an artificial intelligence model to generate a plurality of feature points. Each of feature points has a feature point coordinate. The image generating module saves a lookup table and a default grid model having a plurality of grid points. The number of the feature points is equal to the number of the grid points. The lookup table records the grid point coordinate of the grid point corresponding to the feature point coordinate of each of the feature points. The image generating module finds out the feature points matching the grid points, and aligns at least a portion of the grid points with the feature points corresponding thereto so as to combine the default grid model with the face and generate a real-time three-dimensional (3D) face model. The image combining module combines the real-time 3D face model with a decorative image to generate a combined image. Through the above face positioning mechanism, the image generating module can accurately generate a real-time 3D face model fitting the shape of the face in the image so as to enhance the face positioning precision without fragmenting the real-time 3D face model. Consequently, the image combining module can more accurately combine the real-time 3D face model with the decorative image to generate the combined image. Thus, the image generating system can be applicable to the applications requiring precise face positioning or accurately generating facial mask objects, so the image generating system can be more comprehensive in application.

(2) In an embodiment of the present invention, the image generating module of the image generating system can align at least a portion of the grid points the feature points corresponding thereto without breaking or distorting the default grid model. Additionally, the image generating module can arrange the grid points not matching the feature points according to the shape of the default grid model, and can also arrange the feature points unable to be identified according to the shape of the default grid model. Therefore, even if a part of the face in the image cannot be detected, the image generating module can achieve high recognition accuracy so as to further enhance the performance of the image generating system.

(3) In an embodiment of the present invention, the image generating system has a special facial positioning mechanism that can be executed not only through the inference computation of a graphics processing unit (GPU) but also through the inference computation of a central-processing unit (CPU). Therefore, the image generating system is not only compatible with various computer devices but also with smartphones and other similar devices in order to provide a great user experience for the user.

(4) In an embodiment of the present invention, the image generating system can support different input image formats (e.g., 128, 160, 192, 224, 256), so the user can switch the input image format of the image generating system according to actual requirements. Consequently, the image generating system can be more flexible in use with a view to meeting the requirements of different users.

(5) In an embodiment of the present invention, the files generated by the image generating system are small in size and can achieve the desired effects without consuming a large number of computational resources, so the image generating system can be applicable to web pages. Therefore, the image generating system can achieve higher practicality so as to satisfy actual requirements.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a block diagram of an image generating system having high face positioning precision in accordance with one embodiment of the present invention.

FIG. 2 is a schematic view of an analysis result of an image converting module of the image generating system having high face positioning precision in accordance with one embodiment of the present invention.

FIG. 3 is a schematic view of a default grid model of an image generating module of the image generating system having high face positioning precision in accordance with one embodiment of the present invention.

FIG. 4 is a schematic view of a real-time three-dimensional face model of the image generating module of the image generating system having high face positioning precision in accordance with one embodiment of the present invention.

FIG. 5 is a first schematic view of the image generating system having high face positioning precision in accordance with one embodiment of the present invention.

FIG. 6 is a second schematic view of the image generating system having high face positioning precision in accordance with one embodiment of the present invention.

FIG. 7 is a flow chart of an image generating method having high face positioning precision in accordance with one embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

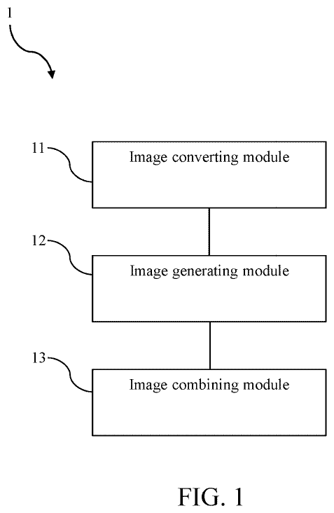

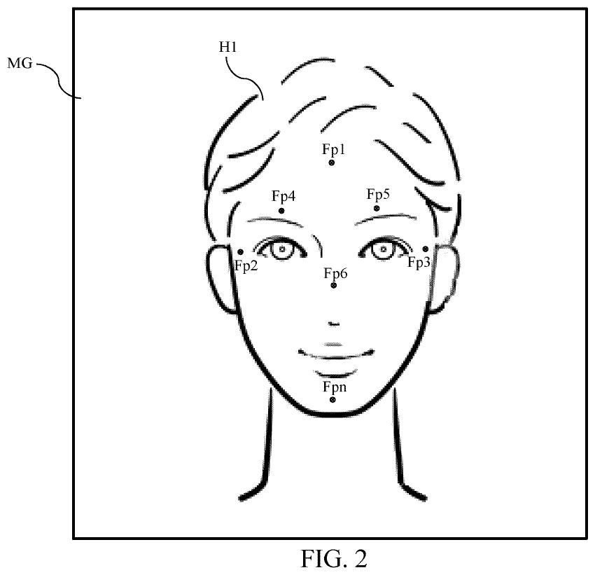

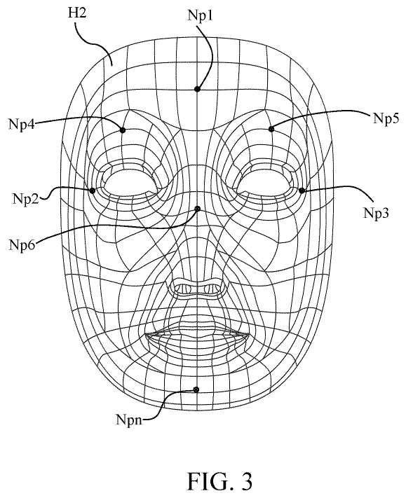

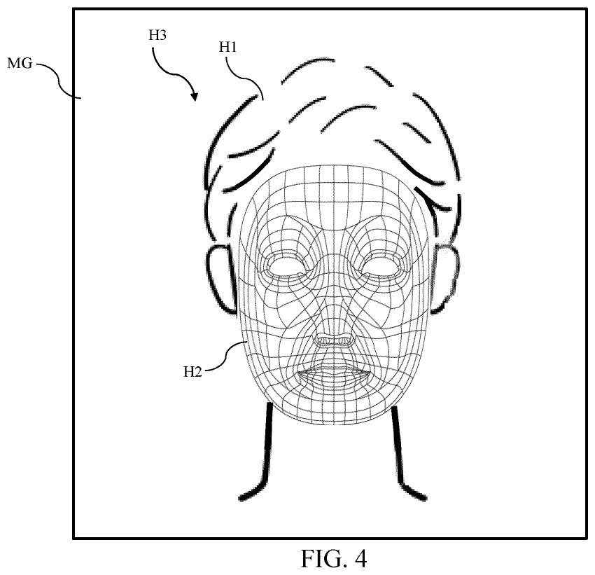

Please refer to FIG. 1, FIG. 2, FIG. 3 and FIG. 4. FIG. 1 is a block diagram of an image generating system having high face positioning precision in accordance with one embodiment of the present invention. FIG. 2 is a schematic view of an analysis result of an image converting module of the image generating system having high face positioning precision in accordance with one embodiment of the present invention. FIG. 3 is a schematic view of a default grid model of an image generating module of the image generating system having high face positioning precision in accordance with one embodiment of the present invention. FIG. 4 is a schematic view of a real-time three-dimensional face model of the image generating module of the image generating system having high face positioning precision in accordance with one embodiment of the present invention. As shown in FIG. 1, the image generating system 1 includes an image converting module 11, an image generating module 12, and an image combining module 13.

The image converting module 11 can receive continuous images inputted from an image capturing module (such as a camera, smartphone, tablet, laptop, etc.). Then, as shown in FIG. 1 and FIG. 2, the image converting module 11 can analyze the face H1 in each image MG through an artificial intelligence model to generate a plurality of feature points Fp1 to Fpn (only a few feature points are shown in FIG. 2), each of which has a feature point coordinate. For example, the coordinate of the feature point Fp1 is (x1, y1); the coordinate of the feature point Fp2 is (x2, y2); the coordinate of feature point Fp3 is (x3, y3); the coordinate of the feature point Fp4 is (x4, y4); the coordinate of the feature point Fp5 is (x5, y5); the coordinate of the feature point Fp6 is (x6, y6). In one embodiment, the artificial intelligence model can be the combination of BiSeNet and MobileNet, which can achieve real-time performance, reduce feature point loss, and high efficiency. In another embodiment, the artificial intelligence model can also be ResNet or other similar models. In one embodiment, the image converting module 11 can be a graphics processing unit (GPU), a central-processing unit (CPU), a microcontroller unit (MCU), an application-specific integrated circuit (ASIC), a field-programmable gate array (FPGA), or other similar components. In another embodiment, the image converting module 11 can also be a software module.

As shown in FIG. 1 and FIG. 3, the image generating module 12 saves a lookup table and a default grid model H2 with a plurality of grid points Np1 to Fpn. The default grid model H2 may be a three-dimensional face model manufactured according to an average face. The number of the feature points Fp1 to Fpn is equal to the number of the grid points Np1 to Npn. For example, the coordinate of the grid point Np1 is (x1′, y1′); the coordinate of the grid point Np2 is (x2′, y2′); the coordinate of the grid point Np3 is (x3′, y3′); the coordinate of grid point Np4 is (x4′, y4′); the coordinate of the grid point Np5 is (x5′, y5′); the coordinate of the grid point Np6 is (x6′, y6′). The coordinates of the feature points Fp1 to Fpn are corresponding to those of the grid points Np1 to Npn. In this embodiment, the number of the feature points Fp1 to Fpn can be, but not limited to, 1293 (the number of the feature points Fp1 to Fpn is equal to the number of the grid points Np1 to Npn). In another embodiment, the number of these feature points Fp1 to Fpn may be between 900 and 2000 (the number of the feature points Fp1 to Fpn is equal to the number of the grid points Np1 to Npn). In yet another embodiment, the number of these feature points Fp1˜Fpn can be between 360 and 12000 or greater than 12000 (the number of the feature points Fp1 to Fpn is equal to the number of the grid points Np1 to Npn). In one embodiment, the image generating module 12 can be a graphics processing unit (GPU), a central-processing unit (CPU), a microcontroller unit (MCU), an application-specific integrated circuit (ASIC), a field-programmable gate array (FPGA), or other similar components. In another embodiment, the image generating module 12 can also be a software module.

As shown in FIG. 1 and FIG. 4, the image generating module 12 finds out the feature points Fp1 to Fpn matching the grid points Np1 to Npn according to the lookup table, and aligns at least a portion of the grid points Np1 to Npn with the feature points Fp1 to Fpn corresponding thereto to combine the default grid model H2 with the face H1 so as to generate a real-time 3D face model H3. The image generating module 12 appropriately scales the default grid model H2 based on the analysis result thereof without breaking or distorting the default grid model H2 so as to make the shape of the default grid model H2 match the face H1, thereby combining the default grid model H2 with the face H1 and generating a real-time 3D face model H3. Through the aforementioned face positioning mechanism, the image generating system 1 can process consecutive images by the same mechanism in order to generate a video with the real-time 3D face model H3.

If the image MG can display the entire face H1, the image generating module 12 appropriately scales the default grid model H2 according to the analysis result thereof without breaking or distorting the default grid model H2 so as to make the shape of the default grid model H2 match the face H1, thereby combining the default grid model H2 with the face H1 and generating the real-time 3D face model H3.

If the image MG can only display a portion of the face H1, only a portion of those grid points Np1 to Npn can be align with the feature points Fp1 to Fpn corresponding thereto. In this case, the image generating module 12 arranges the grid points unmatched with those feature points according to the shape of the default grid model H2. Then, the image generating module 12 appropriately scales the default grid model H2 according to the analysis results thereof without breaking or distorting the default grid model H2 so as to make the shape of the default grid model H2 match the face H1, thereby combining the default grid model H2 with the face H1 and generating the real-time 3D face model H3.

If one or more feature points deviate significantly from their original positions due to computational errors, the image generating module 12 determines these feature points as unrecognizable. In this case, the image generating module 12 arranges the grid points matched with the unrecognizable feature points according to the shape of the default grid model H2. Then, the image generating module 12 appropriately scales the default grid model H2 based on the analysis result thereof without breaking or distorting the default grid model H2 in order to make the shape of the default grid model H2 match the face H1, thereby combining the default grid model H2 with the face H1 and generating the real-time 3D face model H3.

The embodiment just exemplifies the present invention and is not intended to limit the scope of the present invention; any equivalent modification and variation according to the spirit of the present invention is to be also included within the scope of the following claims and their equivalents.

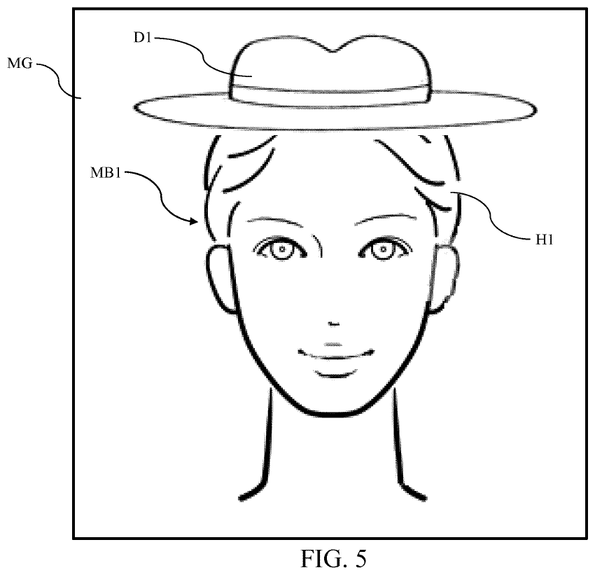

Please refer to FIG. 5, which is a first schematic view of the image generating system having high face positioning precision in accordance with one embodiment of the present invention. Please also refer to FIG. 1. As shown in FIG. 5, through the aforementioned image processing method, the image combining module 13 can combine the real-time 3D face model H3 with the decorative image D1 to generate a combined image MB1. In this embodiment, the decorative image D1 can be a hat. In another embodiment, the decorative image D1 can be glasses, earrings, beard, makeup, tattoos, and similar items. In one embodiment, the image combining module 13 can be a graphics processing unit (GPU), a central-processing unit (CPU), a microcontroller unit (MCU), an application-specific integrated circuit (ASIC), a field-programmable gate array (FPGA), or other similar components. In another embodiment, the image combining module 13 may also be a software module.

The embodiment just exemplifies the present invention and is not intended to limit the scope of the present invention; any equivalent modification and variation according to the spirit of the present invention is to be also included within the scope of the following claims and their equivalents.

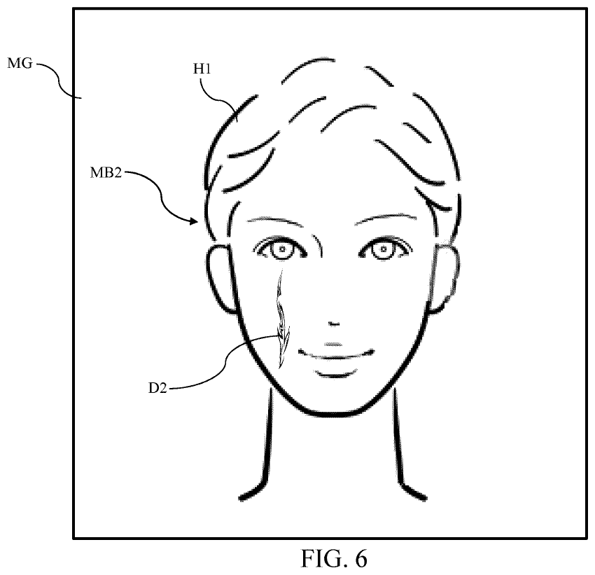

Please refer to FIG. 6, which is a second schematic view of the image generating system having high face positioning precision in accordance with one embodiment of the present invention. Please also refer to FIG. 1. As shown in FIG. 6, through the aforementioned image processing method, the image combining module 13 can combine the real-time 3D face model H3 with the decorative image D2 to generate a combined image MB2. In this embodiment, the decorative image D2 can be a tattoo.

The embodiment just exemplifies the present invention and is not intended to limit the scope of the present invention; any equivalent modification and variation according to the spirit of the present invention is to be also included within the scope of the following claims and their equivalents.

It is worthy to point out that the currently available image generation systems usually perform face landmark detection based on two-dimensional coordinate information (such as 106 feature points) to identify faces in images, in order to combine decorative elements (such as hats, beards, glasses, etc.) with the faces in the images. in this way, the combined images can be generated. However, images generated via the above techniques may suffer from fragmentation or distortion. Therefore, the currently available image generation systems still need to be further improved. By contrast, according to one embodiment of the present invention, the image generating system having high face positioning precision includes an image converting module, an image generating module and an image combining module. The image converting module analyzes the face of an image via an artificial intelligence model to generate a plurality of feature points. Each of feature points has a feature point coordinate. The image generating module saves a lookup table and a default grid model having a plurality of grid points. The number of the feature points is equal to the number of the grid points. The lookup table records the grid point coordinate of the grid point corresponding to the feature point coordinate of each of the feature points. The image generating module finds out the feature points matching the grid points, and aligns at least a portion of the grid points with the feature points corresponding thereto so as to combine the default grid model with the face and generate a real-time three-dimensional (3D) face model. The image combining module combines the real-time 3D face model with a decorative image to generate a combined image. Through the above face positioning mechanism, the image generating module can accurately generate a real-time 3D face model fitting the shape of the face in the image so as to enhance the face positioning precision without fragmenting the real-time 3D face model. Consequently, the image combining module can more accurately combine the real-time 3D face model with the decorative image to generate the combined image. Thus, the image generating system can be applicable to the applications requiring precise face positioning or accurately generating facial mask objects, so the image generating system can be more comprehensive in application.

Also, according to one embodiment of the present invention, the image generating module of the image generating system can align at least a portion of the grid points the feature points corresponding thereto without breaking or distorting the default grid model. Additionally, the image generating module can arrange the grid points not matching the feature points according to the shape of the default grid model, and can also arrange the feature points unable to be identified according to the shape of the default grid model. Therefore, even if a part of the face in the image cannot be detected, the image generating module can achieve high recognition accuracy so as to further enhance the performance of the image generating system.

Further, according to one embodiment of the present invention, the image generating system has a special facial positioning mechanism that can be executed not only through the inference computation of a graphics processing unit (GPU) but also through the inference computation of a central-processing unit (CPU). Therefore, the image generating system is not only compatible with various computer devices but also with smartphones and other similar devices in order to provide a great user experience for the user.

Moreover, according to one embodiment of the present invention, the image generating system can support different input image formats (e.g., 128, 160, 192, 224, 256), so the user can switch the input image format of the image generating system according to actual requirements. Consequently, the image generating system can be more flexible in use with a view to meeting the requirements of different users.

Furthermore, according to one embodiment of the present invention, the files generated by the image generating system are small in size and can achieve the desired effects without consuming a large number of computational resources, so the image generating system can be applicable to web pages. Therefore, the image generating system can achieve higher practicality so as to satisfy actual requirements. As set forth above, the image generating system having high face positioning precision according to the embodiments of the present invention can indeed achieve great technical effects.

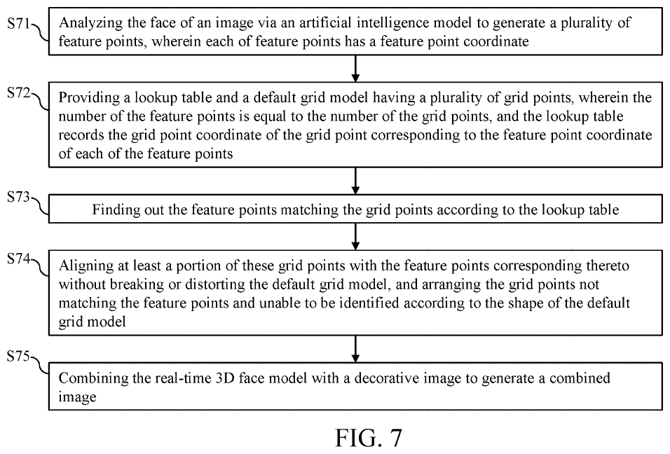

Please refer to FIG. 7, which is a flow chart of an image generating method having high face positioning precision in accordance with one embodiment of the present invention. As shown in FIG. 7, the image generating method having high face positioning precision according to the embodiment of the present invention includes the following steps:

Step S71: analyzing the face of an image via an artificial intelligence model to generate a plurality of feature points, wherein each of feature points has a feature point coordinate.

Step S72: providing a lookup table and a default grid model having a plurality of grid points, wherein the number of the feature points is equal to the number of the grid points, and the lookup table records the grid point coordinate of the grid point corresponding to the feature point coordinate of each of the feature points.

Step S73: finding out the feature points matching the grid points according to the lookup table.

Step S74: aligning at least a portion of these grid points with the feature points corresponding thereto without breaking or distorting the default grid model, and arranging the grid points not matching the feature points and unable to be identified according to the shape of the default grid model.

Step S75: combining the real-time 3D face model with a decorative image to generate a combined image.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the present invention, the image generating system having high face positioning precision includes an image converting module, an image generating module and an image combining module. The image converting module analyzes the face of an image via an artificial intelligence model to generate a plurality of feature points. Each of feature points has a feature point coordinate. The image generating module saves a lookup table and a default grid model having a plurality of grid points. The number of the feature points is equal to the number of the grid points. The lookup table records the grid point coordinate of the grid point corresponding to the feature point coordinate of each of the feature points. The image generating module finds out the feature points matching the grid points, and aligns at least a portion of the grid points with the feature points corresponding thereto so as to combine the default grid model with the face and generate a real-time three-dimensional (3D) face model. The image combining module combines the real-time 3D face model with a decorative image to generate a combined image. Through the above face positioning mechanism, the image generating module can accurately generate a real-time 3D face model fitting the shape of the face in the image so as to enhance the face positioning precision without fragmenting the real-time 3D face model. Consequently, the image combining module can more accurately combine the real-time 3D face model with the decorative image to generate the combined image. Thus, the image generating system can be applicable to the applications requiring precise face positioning or accurately generating facial mask objects, so the image generating system can be more comprehensive in application.

Also, according to one embodiment of the present invention, the image generating module of the image generating system can align at least a portion of the grid points the feature points corresponding thereto without breaking or distorting the default grid model. Additionally, the image generating module can arrange the grid points not matching the feature points according to the shape of the default grid model, and can also arrange the feature points unable to be identified according to the shape of the default grid model. Therefore, even if a part of the face in the image cannot be detected, the image generating module can achieve high recognition accuracy so as to further enhance the performance of the image generating system.

Further, according to one embodiment of the present invention, the image generating system has a special facial positioning mechanism that can be executed not only through the inference computation of a graphics processing unit (GPU) but also through the inference computation of a central-processing unit (CPU). Therefore, the image generating system is not only compatible with various computer devices but also with smartphones and other similar devices in order to provide a great user experience for the user.

Moreover, according to one embodiment of the present invention, the image generating system can support different input image formats (e.g., 128, 160, 192, 224, 256), so the user can switch the input image format of the image generating system according to actual requirements. Consequently, the image generating system can be more flexible in use with a view to meeting the requirements of different users.

Furthermore, according to one embodiment of the present invention, the files generated by the image generating system are small in size and can achieve the desired effects without consuming a large number of computational resources, so the image generating system can be applicable to web pages. Therefore, the image generating system can achieve higher practicality so as to satisfy actual requirements.

It should also be noted that at least some of the operations for the methods described herein may be implemented using software instructions stored on a computer useable storage medium for execution by a computer (or a processor). As an example, an embodiment of a computer program product includes a computer useable storage medium to store a computer readable program.

The computer useable or computer readable storage medium can be an electronic, magnetic, optical, electromagnetic, infrared, or semiconductor system (or apparatus or device). Examples of non-transitory computer useable and computer readable storage media include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention (or the image converting module 11, the image generating module 12 and the image combining module 13 of the image generating system 1) may be implemented entirely in hardware, entirely in software or in an implementation containing both hardware and software elements. In embodiments which use software, the software may include, but not limited to, firmware, resident software, microcode, etc. In embodiments which use hardware, the hardware may be implemented within one or more application specific integrated circuits (ASICs), digital signal processors (DSPs), digital signal processing devices (DSPDs), programmable logic devices (PLDs), field programmable gate arrays (FPGAs), central-processing unit (CPU), controllers, micro-controllers, microprocessors, electronic devices, other electronic units designed to perform the functions described herein, or a combination thereof.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image generating system having high face positioning precision, comprising:
an image converting module configured to analyze a face of an image via an artificial intelligence model to generate a plurality of feature points, wherein each of feature points has a feature point coordinate; and
an image generating module configured to save a lookup table and a default grid model having a plurality of grid points, wherein a number of the feature points is equal to a number of the grid points, wherein the lookup table records a grid point coordinate of the grid point corresponding to the feature point coordinate of each of the feature points;
wherein the image generating module is configured to find out the feature points matching the grid points, and align at least a portion of the grid points with the feature points corresponding thereto so as to combine the default grid model with the face and generate a real-time three-dimensional (3D) face model.

2. The image generating system having high face positioning precision as claimed in claim 1, wherein the image generating module is configured to align at least a portion of the grid points with the feature points corresponding thereto without breaking or distorting the default grid model.

3. The image generating system having high face positioning precision as claimed in claim 1, wherein the image generating module is configured to arrange the grid points not matching the feature points according to a shape of the default grid model.

4. The image generating system having high face positioning precision as claimed in claim 3, wherein the image generating module is configured to arrange the feature points unable to be identified by the image generating module according to the shape of the default grid model.

5. The image generating system having high face positioning precision as claimed in claim 1, further comprising an image combining module configured to combine the real-time 3D face model with a decorative image to generate a combined image.

6. An image generating method having high face positioning precision, comprising:
analyzing a face of an image via an artificial intelligence model to generate a plurality of feature points, wherein each of feature points has a feature point coordinate;
providing a lookup table and a default grid model having a plurality of grid points, wherein a number of the feature points is equal to a number of the grid points, and the lookup table records a grid point coordinate of the grid point corresponding to the feature point coordinate of each of the feature points;
finding out the feature points matching the grid points according to the lookup table; and
aligning at least a portion of the grid points with the feature points corresponding thereto so as to combine the default grid model with the face and generate a real-time 3D face model.

7. The image generating method having high face positioning precision as claimed in claim 6, wherein a step of aligning at least a portion of the grid points with the feature points corresponding thereto so as to combine the default grid model with the face and generate the real-time 3D face model further comprises:
aligning at least a portion of these grid points with the feature points corresponding thereto without breaking or distorting the default grid model.

8. The image generating method having high face positioning precision as claimed in claim 6, further comprising:
arranging the grid points not matching the feature points according to a shape of the default grid model.

9. The image generating method having high face positioning precision as claimed in claim 8, further comprising:
arranging the feature points unable to be identified according to the shape of the default grid model.

10. The image generating method having high face positioning precision as claimed in claim 6, further comprising:
combining the real-time 3D face model with a decorative image to generate a combined image.
